(19) United States
(12) Patent Application Publication
(10) Pub. No.: US 2026/0030151 A1
(43) Pub. Date: Jan. 29, 2026

(54) STORAGE SYSTEM AND OPERATING METHOD THEREOF

(71) Applicant: SK hynix Inc., Gyeonggi-do (KR)

(72) Inventor: Hee Chang KIM, Gyeonggi-do (KR)

(21) Appl. No.: 18/925,014

(22) Filed: Oct. 24, 2024

(30) Foreign Application Priority Data
Jul. 24, 2024 (KR) 10-2024-0097691

(51) Int. Cl. G06F 12/02

(52) U.S. Cl. CPC G06F 12/0246

(57) ABSTRACT

A controller included in a storage system which performs based on an original data unit, a compression operation on each of augmented data units to generate one or more alteration information units respectively corresponding to the augmented data units; and which stores original data unit and the alteration information units in the storage device.

### CROSS-REFERENCE TO RELATED APPLICATIONS

The present application claims priority under 35 U.S.C 119 (a) to Korean Patent Application No. 10-2024-0097691, filed on Jul. 24, 2024, in the Korean Intellectual Property Office, which is incorporated herein by reference in its entirety.

### BACKGROUND

### 1. Field

Exemplary embodiments of the present invention relate to a storage system and an operating method thereof.

### 2. Description of the Related Art

Deep Learning is a sub-field of Artificial Intelligence (AI) and Machine Learning, and it is a technology of predicting the future by learning the present from data through an algorithm based on an artificial neural network. Deep Learning is particularly effective for issues requiring a massive data set and complex pattern recognition.

The core part of Deep Learning is an artificial neural network. An artificial neural network is a mathematical model that mimics the structure and function of the human brain. The artificial neural network is formed of nodes of multiple layers. Each node receives an input value, applies a weight and a bias to the input value, and each node generates an output through an activation function.

The term ‘Deep’ in Deep Learning refers to the multiple layers. The layers generally include an input layer, hidden layers and an output layer. As there are more hidden layers, the network may become ‘deeper’ and learn more complex patterns.

Deep learning schemes use normalization techniques to prevent deep learning models from overfitting. Representative normalization techniques may include dropout and batch normalization.

In deep learning technology, data augmentation is a technique that expands and diversifies learning data sets to improve the generalization capability of a model. The data augmentation is especially useful in a situation where data are limited, such as image processing. The data augmentation transforms original data to generate a new data sample, allowing the model to cope with diverse situations.

The data augmentation can maximize the performance of a deep learning model and improve the generalization capability. A proper use of diverse augmentation techniques may significantly improve the learning effect of the model.

There are several issues related to the learning data in the learning operation of a deep learning model (which will be, hereinafter, simply referred to as a learning operation). The issues are as follows.
Insufficient learning data: There are situations where the amount of learning data is insufficient due to reasons such as excessive actual experimental time required for securing the learning data.
Imbalance of learning data classes: In one case of learning fault judgment models, the learning data may include data representing normal situations and data representing fault situations and, generally, there are more data representing normal situations. In this case, it is required to increase the data representing fault situations.
Overfitting: In a case where the learning data is optimized too much for a training situation, the learning data may have a high accuracy for the training situation, but the learning data may have a low accuracy when an actual test is performed based on the learning model.

One scheme that may solve the above issues is data augmentation. A data augmentation operation may be performed on an original data unit ODU to generate an augmented data unit ADU. The original data unit ODU and the augmented data unit ADU may become the target of a learning operation and the learning operation may be performed.

### SUMMARY

Embodiments of the present invention are directed to a storage system and an operating method thereof which may compress an augmented data unit ADU generated from an original data unit ODU to generate a compressed augmented data unit CADU and store the compressed augmented data unit CADU in a storage and then may decompress, during a learning operation of a host system, the compressed augmented data unit CADU to restore the augmented data unit ADU and provide the host system with the restored augmented data unit ADU.

The technical issues addressed in the embodiments of the present invention are not limited to the technical issues mentioned above and other technical issues not mentioned above may also be clearly understood by those of ordinary skill in the art to which the present invention pertains from the description below.

In accordance with one embodiment of the present invention, an operating method of a data processing system including a host system and a storage system may include: providing, by the host system, the storage system with an original data unit and augmented data units, which are a result of a data augmentation operation performed on the original data unit; performing, by the storage system and based on an original data unit, a compression operation on each of the augmented data units to generate one or more alteration information units respectively corresponding to the augmented data units; and storing, by the storage system, the original data unit and the alteration information units in a storage device included in the storage system. The alteration information unit may include at least one among an operation code field, a location field, a length field and an altered content field.

The operation code field may have a value representing the data augmentation operation.

The location field may have a value corresponding to a starting location of one or more data pieces, which are transformed by the data augmentation operation within the original data unit.

The length field may have a value corresponding to a length of the one or more data pieces.

The altered content field may have a value corresponding to the one or more data pieces.

The method may further include providing, by the host system, the storage system with batch information.

The batch information may include information on augmented data units, which correspond to the alteration information units stored in the storage system and are grouped in units of batches.

The method may further include providing, by the storage system, the host system with address information.

The address information may represent at least a partial space within the storage system.

The method may further include restoring, by the storage system and based on the original data unit and the alteration information units respectively corresponding to the augmented data units grouped in units of batches and represented by the batch information, the augmented data units grouped in units of batches.

The method may further include storing, by the storage system and in the partial space, the restored augmented data units grouped in unit of batches.

The method may further include acquiring, by the host system and from the partial space, the stored augmented data units grouped in units of batches; and clearing, by the storage system, the partial space.

In accordance with another embodiment of the present invention, an operating method of a data processing system including a host system and a storage system may include: performing, by the host system and based on an original data unit, a compression operation on each of the augmented data units to generate one or more alteration information units respectively corresponding to the augmented data units, the augmented data units being a result of a data augmentation operation performed on the original data unit; providing, by the host system, the storage system with the original data unit and the alteration information units; and storing, by the storage system and in a storage device included therein, the original data unit and the alteration information units.

The alteration information unit may include at least one among an operation code field, a location field, a length field and an altered content field.

The operation code field may have a value representing the data augmentation operation.

The location field may have a value corresponding to a starting location of one or more data pieces, which are transformed by the data augmentation operation within the original data unit.

The length field may have a value corresponding to a length of the one or more data pieces.

The altered content field may have a value corresponding to the one or more data pieces.

The method may further include providing, by the host system, the storage system with batch information.

The batch information may include information on augmented data units, which correspond to the alteration information units stored in the storage system and are grouped in units of batches.

The method may further include providing, by the storage system, the host system with address information.

The address information may represent at least a partial space within the storage system.

The method may further include restoring, by the storage system and based on the original data unit and the alteration information units respectively corresponding to the augmented data units grouped in units of batches and represented by the batch information, the augmented data units grouped in units of batches.

The method may further include storing, by the storage system and in the partial space, the restored augmented data units grouped in unit of batches.

The method may further include acquiring, by the host system and from the partial space, the stored augmented data units grouped in units of batches; and clearing, by the storage system, the partial space.

In accordance with another embodiment of the present invention, an operating method of a controller may include: restoring, based on an original data unit and alteration information units respectively corresponding to augmented data units grouped in units of batches and represented by batch information, the augmented data units grouped in units of batches, the augmented data units being a result of a data augmentation operation performed on the original data, and the original data unit and the alteration information units being stored in a storage device; and controlling a memory device to store, in at least a partial space within the memory device, the restored augmented data units grouped in unit of batches.

The alteration information unit may include at least one among an operation code field, a location field, a length field and an altered content field.

The operation code field may have a value representing the data augmentation operation.

The location field may have a value corresponding to a starting location of one or more data pieces, which are transformed by the data augmentation operation within the original data unit.

The length field may have a value corresponding to a length of the one or more data pieces.

The altered content field may have a value corresponding to the one or more data pieces.

The method may further include receiving the batch information.

The batch information may include information on augmented data units, which correspond to the alteration information units stored in the storage system and are grouped in units of batches.

The method may further include providing address information to an exterior.

The address information may represent the partial space.

The method may further include before the restoring: performing, based on the original data unit, a compression operation on each of the augmented data units to generate the alteration information units respectively corresponding to the augmented data units; and controlling the storage device to store the original data unit and the generated alteration information units in the storage device.

The method may further include before the restoring: receiving the original data unit and the alteration information units from the exterior; and controlling the storage device to store the received original data unit and the alteration information units in the storage device.

The method may further include controlling the memory device to clear the partial space when the stored augmented data units grouped in units of batches are provided from the partial space to an exterior.

In accordance with another embodiment of the present invention, a storage system may include a storage device and a controller.

The controller may be configured to perform, based on an original data unit, a compression operation on each of augmented data units to generate one or more alteration information units respectively corresponding to the augmented data units, the original data unit and the augmented data units being provided from a host system and the augmented data units being a result of a data augmentation operation performed on the original data unit; and store the original data unit and the alteration information units in the storage device.

The alteration information unit may include at least one among an operation code field, a location field, a length field and an altered content field.

The operation code field may have a value representing the data augmentation operation.

The location field may have a value corresponding to a starting location of one or more data pieces, which are transformed by the data augmentation operation within the original data unit.

The length field may have a value corresponding to a length of the one or more data pieces.

The altered content field may have a value corresponding to the one or more data pieces.

The controller may be further configured to receive batch information provided from the host system.

The batch information may include information on augmented data units, which correspond to the alteration information units stored in the storage system and are grouped in units of batches.

The storage system may further include a memory device.

The controller may be further configured to provide the host system with address information.

The address information may represent at least a partial space within the memory device.

The controller may be further configured to restore, based on the original data unit and the alteration information units respectively corresponding to the augmented data units grouped in units of batches and represented by the batch information, the augmented data units grouped in units of batches.

The controller may be further configured to store, in the partial space, the restored augmented data units grouped in unit of batches.

The controller may be further configured to clear the partial space after the host system acquires, from the partial space, the stored augmented data units grouped in units of batches.

In accordance with an embodiment of the present invention, a storage system may include a storage device and a controller.

The controller may be configured to store, in the storage device, an original data unit and one or more alteration information units, the original data unit and the alteration information units being provided from a host system, the alteration information units respectively corresponding to augmented data units and the augmented data units being a result of a data augmentation operation performed on the original data unit.

The alteration information unit may include at least one among an operation code field, a location field, a length field and an altered content field.

The operation code field may have a value representing the data augmentation operation.

The location field may have a value corresponding to a starting location of one or more data pieces, which are transformed by the data augmentation operation within the original data unit.

The length field may have a value corresponding to a length of the one or more data pieces.

The altered content field may have a value corresponding to the one or more data pieces.

The controller may be further configured to receive batch information provided from the host system.

The batch information may include information on augmented data units, which correspond to the alteration information units stored in the storage system and are grouped in units of batches.

The storage system may further include a memory device.

The controller may be further configured to provide the host system with address information.

The address information may represent at least a partial space within the memory device.

The controller may be further configured to restore, based on the original data unit and the alteration information units respectively corresponding to the augmented data units grouped in units of batches and represented by the batch information, the augmented data units grouped in units of batches.

The controller may be further configured to store, in the partial space, the restored augmented data units grouped in unit of batches.

The controller may be further configured to clear the partial space after the host system acquires, from the partial space, the stored augmented data units grouped in units of batches.

In accordance with another embodiment of the present invention, an operating method of a storage system may include: performing, based on an original data unit, a compression operation on each of augmented data units to generate one or more alteration information units respectively corresponding to the augmented data units, the original data unit and the augmented data units being provided from a host system and the augmented data units being a result of a data augmentation operation performed on the original data unit; and storing the original data unit and the alteration information units in a storage device.

The alteration information unit includes at least one among an operation code field, a location field, a length field and an altered content field.

The operation code field may have a value representing the data augmentation operation.

The location field may have a value corresponding to a starting location of one or more data pieces, which are transformed by the data augmentation operation within the original data unit.

The length field may have a value corresponding to a length of the one or more data pieces.

The altered content field may have a value corresponding to the one or more data pieces.

The method may further include receiving batch information from the host system.

The batch information may include information on augmented data units, which correspond to the alteration information units stored in the storage system and are grouped in units of batches.

The method may further include providing the host system with address information.

The address information may represent at least a partial space within the storage system.

The method may further include restoring, based on the original data unit and the alteration information units respectively corresponding to the augmented data units grouped in units of batches and represented by the batch information, the augmented data units grouped in units of batches.

The method may further include storing, in the partial space, the restored augmented data units grouped in unit of batches.

The method may further include clearing the partial space after the host system acquires, from the partial space, the stored augmented data units grouped in units of batches.

### BRIEF DESCRIPTION OF THE DRAWINGS

FIG. 1 is a block diagram illustrating a data processing system, to which one embodiment of the present invention is applicable.

FIG. 2 is a transaction diagram illustrating an operation between a storage system and a host system in accordance with another embodiment of the present invention.

FIG. 3 is an exemplary diagram illustrating an original data unit in accordance with another embodiment of the present invention.

FIG. 4 is an exemplary diagram illustrating an augmented data unit in accordance with another embodiment of the present invention.

FIG. 5 is an exemplary diagram illustrating an alteration information unit in accordance with another embodiment of the present invention.

FIG. 6 is an exemplary diagram illustrating a storage, in which a compressed augmented data unit is stored, in accordance with another embodiment of the present invention.

FIG. 7 is a transaction diagram illustrating an operation between a host system and a storage system in accordance with another embodiment of the present invention.

FIG. 8 is a transaction diagram illustrating an operation between a host system and a storage system in accordance with another embodiment of the present invention.

FIG. 9 is an exemplary diagram illustrating a part of the processes illustrated in FIG. 8.

### DETAILED DESCRIPTION

Hereinafter, the various embodiments of the present invention will be described in detail with reference to the attached drawings. The embodiments of the present invention are provided to help those of ordinary skill in the art understand the technical spirit of the present disclosure. The present invention may be realized in diverse embodiments and the present invention may be described by illustrating and presenting specific embodiments in the figures. However, this is not intended to limit the present invention to a specific disclosed form, but it should be understood to include all modifications, equivalents, or substitutes included in the technical scope of the present invention. In the description of each figure, like reference numerals may be used for like constituent elements. In the attached drawings, the dimensions of structures are illustrated in an enlarged or reduced form compared to the actual size in order to clearly ensure the features of the present invention.

The terminology used herein is for the purpose of describing particular embodiments only and is not intended to be limiting. In the present disclosure, the singular forms are intended to include the plural forms as well, unless the context clearly indicates otherwise. It will be further understood that the terms “comprise”, “include”, “have”, etc. When used in this specification, specify the presence of stated features, numbers, steps, operations, elements, components and/or combinations of them but do not preclude the presence or addition of one or more other features, numbers, steps, operations, elements, components and/or combinations thereof.

It will be understood that, although the terms “first” and/or “second” may be used herein to describe various elements, these elements should not be limited by these terms. These terms are only used to distinguish one element, from another element. For instance, a first element discussed below could be termed a second element without departing from the teachings of the present disclosure. Similarly, the second element could also be termed the first element.

Unless otherwise defined, all terms including technical and scientific terms used herein have the same meaning as commonly understood by one of ordinary skill in the art to which the present disclosure belongs.

During a learning operation, a large amount of original data units ODUs and augmented data units ADUs may be required and the amount may be too large to be stored in a memory with a small capacity such as Dynamic Random Access Memory (DRAM). Therefore, a separate storage may be required to store therein the original data units ODU as well as the augmented data units ADU. Since the augmented data unit ADU is not the original data unit ODU, but the data transformed from the original data unit ODU, it preferably, but not necessarily, is stored as separate data different from the original data unit ODU. The augmented data unit ADU may have the same or a similar size as the original data unit ODU and therefore, more storage space may be required to store therein the augmented data unit ADU.

When the augmented data unit ADU is stored in a storage through a general compression method (e.g., zip, mpeg scheme, etc.), there is an issue in that the host system requires resources for restoring the compressed augmented data unit ADU because the host system has to decompress the compressed augmented data unit ADU and restore it into the augmented data unit ADU.

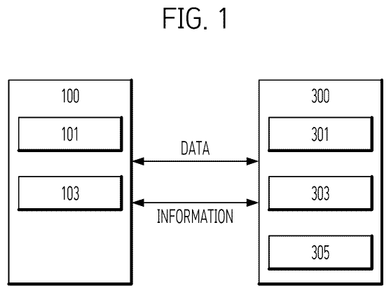

FIG. 1 is a block diagram illustrating a data processing system, to which one embodiment of the present invention is applicable.

Referring to FIG. 1, the data processing system to which the embodiment of the present invention may be applied may be a deep learning model learning system. In the present disclosure, deep learning may be used as a concept encompassing artificial intelligence learning and machine learning.

The data processing system may include a host system 100 and a storage system 300 in accordance with one embodiment of the present invention.

The host system 100 may communicate with the storage system 300 by using at least one among diverse communication methods, such as for example USB (Universal Serial Bus), SATA (Serial AT Attachment), SAS (Serial Attached SCSI), HSIC (High Speed Interchip), SCSI (Small Computer System Interface), PCI (Peripheral Component Interconnection), PCIe (PCI express), NVMe (NonVolatile Memory express), UFS (Universal Flash Storage), SD (Secure Digital), MMC (MultiMedia Card), eMMC (embedded MMC), DIMM (Dual In-line Memory Module), RDIMM (Registered DIMM), LRDIMM (Load Reduced DIMM) and the like.

When the data processing system is a deep learning model learning system (which may be, hereinafter, simply referred to as a “learning system”), the host system 100 may perform a learning operation. In a case where the data processing system is a learning system, the storage system 300 may receive and store the data required for the learning operation of the host system 100 from the host system 100, or it may provide the host system 100 with the stored data.

In the case where the data processing system is a learning system, the host system 100 and the storage system 300 may exchange information required for the learning operation of the host system 100. As described below, the data exchanged between the host system 100 and the storage system 300 may include an original data unit ODU, an augmented data unit ADU and an alteration information unit AIU. As described below, the information exchanged between the host system 100 and the storage system 300 may include batch information BATIN and address information ADDR.

The host system 100 may include a model learner 101 and an augmented data AD generator 103.

The model learner 101 may perform a learning operation. The model learner 101 may perform a learning operation by using an original data unit ODU and an augmented data unit ADU.

The AD generator 103 may be a pre-processing device for the learning operation of the model learner 101 and may perform a data augmentation operation. The AD generator 103 may generate an augmented data unit ADU from an original data unit ODU through a data augmentation operation. The data augmentation scheme for the data augmentation operation may be a scheme that may generate the augmented data unit ADU and the scheme may be well known to those skilled in the art to which the present invention pertains.

For example, data augmentation has the following advantages.
Prevent Overfitting: It is possible to prevent a model from being overfitted to a specific pattern through diverse transformations.
Improve Generalization: It is possible to improve the prediction performance for new data by learning diverse data samples.
Address Data Scarcity: In a case where the original data are insufficient, it is possible to provide more learning data by securing augmented data that may be generated from the original data through data augmentation.

Examples of the data augmentation scheme may be as follows:
Image Data Augmentation: rotation, horizontal flip, vertical flip, cropping, scaling, translation, brightness adjustment, adding noise, and color jittering
Text Data Augmentation: synonym replacement, random insertion, random deletion, random swap, and back translation
Audio Data Augmentation: pitch shifting, speed change, adding noise, shifting, and adding echo.

The augmented data unit ADU generated by the AD generator 103 may be the data transformed from the original data unit ODU and may be of the same type as the original data unit ODU. The augmented data unit ADU may have the same or similar size as the original data unit ODU.

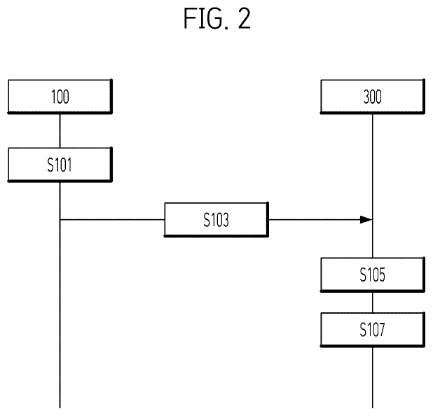

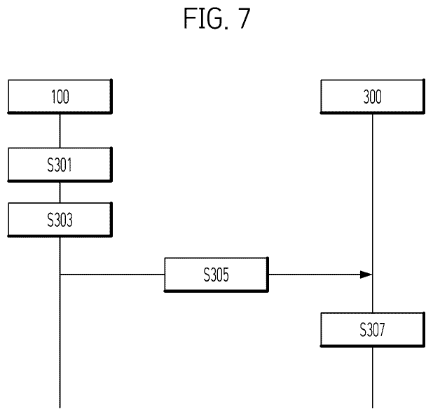

For example, the model learner 101 may control the host system 100 to perform the process that is described with reference to FIGS. 7 to 9. For example, the AD generator 103 may control the host system 100 to perform the process that is described with reference to FIGS. 2 to 7.

Although FIG. 1 illustrates the model learner 101 and the AD generator 103 as separate structures according to the function, the embodiment of the present invention is not limited to the separate structures. The model learner 101 and the AD generator 103 may be realized by being physically integrated into a single circuit or module.

The storage system 300 may operate in response to a request from the host system 100 and, in particular, may store data that are accessed by the host system 100. The storage system 300 may be used as a main memory device or an auxiliary memory device of the host system 100. Here, the storage system 300 may be realized as one among diverse types of storage devices according to the host interface protocol coupled to the host system 100. For example, the storage system 300 may be realized as one among diverse types of storage devices, such as for example a Solid State Drive (SSD), a Multi Media Card (MMC) in the form of an MMC, an embedded MMC (eMMC), a reduced size MMC (RS-MMC) and a micro-MMC, a Secure Digital (SD) card in the form of an SD, mini-SD and micro-SD, a Universal Storage Bus (USB) storage device, a Universal Flash Storage (UFS) device, a Compact Flash (CF) card, a Smart Media card, a memory stick and the like.

The storage system 300 may include a controller 301, a storage device 303 and a buffer memory 305.

The controller 301 and the storage device 303 may be integrated into a single semiconductor device. For example, the controller 301 and the storage device 303 may be integrated into a single semiconductor device and realized as an SSD. When the storage system 300 is realized as an SSD, the operation speed of the host system 100 coupled to the storage system 300 may be further improved. Also, the controller 301 and the storage device 303 may be integrated into a single semiconductor device to form a memory card, such as a PC card (PCMCIA: Personal Computer Memory Card International Association), a compact flash card (CF), a smart media card (e.g., SM, SMC), a memory stick, a multimedia card (e.g., MMC, RS-MMC, MMCmicro), an SD card (e.g., SD, miniSD, microSD, SDHC), a universal flash memory device (UFS) and the like.

Also, for another example, the storage system 300 may form for example a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game console, a navigation device, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage for forming a data center, a device capable of transferring and receiving information in a wireless environment, one among diverse electronic devices that form a home network, one among diverse electronic devices that form a computer network, one among diverse electronic devices that form a telematics network, a Radio Frequency IDentification (RFID) device, or one among diverse components that form a computing system.

The storage device 303 may be able to retain the stored data even when the power is not supplied and particularly the storage device 303 may store the data provided from the host system 100 through a write operation and provide the host system 100 with the stored data through a read operation. Here, the storage device 303 may include a memory cell array that includes a plurality of memory cells for storing data.

The memory cell array may include a plurality of memory blocks. Each memory block may include a plurality of memory cells. A single memory block may include a plurality of pages. According to the embodiment of the present invention, a page may be a unit for storing data in the storage device 303 or reading the data stored in the storage device 303. A memory block may be a unit of data deletion.

The storage device 303 may be formed to receive a command and an address from the controller 301 and access an area selected based on the address in the memory cell array. The storage device 303 may perform an operation represented by the command on the area selected based on the address. For example, the storage device 303 may perform program, read, and erase operations. During the program operation, the storage device 303 may program data in the area selected based on the address. During the read operation, the storage device 303 may read data from the area selected based on the address. During the erase operation, the storage device 303 may erase the data stored in the area selected based on the address.

The controller 301 may control the overall operation of the storage system 300.

When power is applied to the storage system 300, the controller 301 may execute firmware. When the storage device 303 is a flash memory device, the firmware may include a host interface layer, a flash translation layer and a flash interface layer. The host interface may control communication with the host system 100. The flash translation layer may control communication between the host system 100 and the storage device 303. The flash interface layer may control communication with the storage device 303.

According to another embodiment of the present invention, the controller 301 may receive data and a logical address from the host system 100 and transform the logical address into a physical address that represents the address of a memory cell where the data included in the storage device 303 are to be stored.

The controller 301 may control the storage device 303 to perform a program operation, a read operation, or an erase operation upon a request of the host system 100. During a program operation, the controller 301 may provide the storage device 303 with a write command, a physical address and data. During a read operation, the controller 301 may provide the storage device 303 with a read command and a physical address. During an erase operation, the controller 301 may provide the storage device 303 with an erase command and a physical address.

According to another embodiment of the present invention, the controller 301 may independently generate a command, an address and data and may transfer them to the storage device 303, regardless of a request from the host system 100. For example, the controller 301 may provide the storage device 303 with a command, an address and data to perform a read operation and a program operation, which are accompanied when a wear leveling operation, a read reclaim operation, a garbage collection operation and the like are performed.

According to another embodiment of the present invention, the controller 301 may control two or more storage devices 303. In this case, the controller 301 may control the storage devices 303 according to an interleaving method in order to improve the operation performance. The interleaving method may be a method of controlling the operations for the at least two or more storage devices 303 to overlap with each other.

The controller 301 may control the buffer memory 305 and the storage device 303 to perform the process described below. For example, the controller 301 may control the buffer memory 305 and the storage device 303 to perform the process described with reference to FIGS. 2 to 9.

The buffer memory 305 may buffer one or more augmented data units ADUs in units of batches as described below. Therefore, the buffer memory 305 may have a capacity capable of storing at least the batch. The buffered augmented data unit ADU may be provided to the host system 100. The augmented data unit ADU provided to the host system 100 as the buffered augmented data unit ADU may be cleared from the buffer memory 305. The buffer memory 305 may be a volatile memory or a non-volatile memory. For example, the buffer memory 305 may be a DRAM. For example, the buffer memory 305 may be a non-volatile memory which is realized as an SLC.

Hereinafter, an operation of a storage system in accordance with one embodiment of the present invention is described with reference to FIGS. 2 to 9.

FIG. 2 is a transaction diagram illustrating an operation between the storage system 300 and the host system 100 in accordance with this embodiment of the present invention.

Referring to FIG. 2, at operation S101, the host system 100 may perform a data augmentation operation. The host system 100 may generate an augmented data unit ADU from an original data unit ODU through the data augmentation operation.

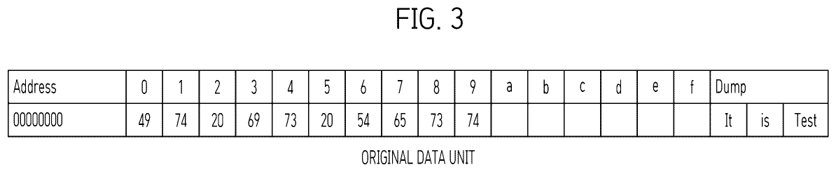

FIG. 3 is an exemplary diagram illustrating an original data unit ODU in accordance with one embodiment of the present invention.

FIG. 3 exemplifies the data corresponding to the text “It is Test” as the original data unit ODU. The code “69 73” corresponding to relative locations “3” and “4” with reference to the starting point of the original data unit ODU exemplarily illustrated in FIG. 3 may correspond to the text “is”.

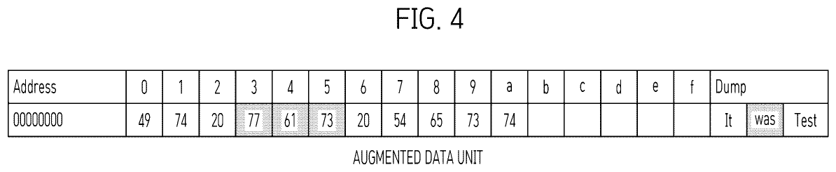

FIG. 4 is an exemplary diagram illustrating an augmented data unit ADU in accordance with one embodiment of the present invention

FIG. 4 illustrates data corresponding to the text “It was Test” as the augmented data unit ADU generated as a result of performing the data augmentation operation on the original data unit ODU. The code “77 61 73” corresponding to the relative locations “3” to “5” with reference to the starting point of the augmented data unit ADU illustrated in FIG. 4 may correspond to the text “was.”

Comparing the original data unit ODU and the augmented data unit ADU illustrated in FIGS. 3 and 4 with each other, the code representing a specific word as the code corresponding to the relative locations “3” and “4” may be transformed to the code corresponding to the relative locations “3” to “5.” In other words, the text “is” is transformed to the text “was.” To summarize the examples of FIGS. 3 and 4, the host system 100 may perform, for the original data unit ODU representing the text “It is Test”, a data augmentation operation of transforming the text “is” to the text “was” to generate an augmented data unit ADU corresponding to the text “It was Test”. As described above, the augmented data unit ADU may be the data transformed from the original data unit ODU and may be of the same type and the same or similar size as the original data unit ODU.

At operation S101, the host system 100 may perform various data augmentation operations to generate a plurality of augmented data units ADUs from a single original data unit ODU. Each of the augmented data units ADUs may correspond to the single original data unit ODU.

Referring back to FIG. 2, at operation S103, the host system 100 may provide the storage system 300 with the original data unit ODU and the augmented data unit ADU, which is generated at operation S101. In a case where a plurality of augmented data units ADUs are generated from a single original data unit ODU at operation S101, the host system 100 at operation S103 may provide the storage system 300 with the single original data unit ODU and the corresponding augmented data units ADUs.

At operation S105, the controller 301 may perform a compression operation on the augmented data unit ADU, which is provided from the host system 100 at operation S103, to generate a compressed augmented data unit CADU. The controller 301 may perform the compression operation based on the original data unit ODU and the augmented data unit ADU provided from the host system 100 at operation S103. The controller 301 may perform the compression operation by comparing the original data unit ODU with the augmented data unit ADU, which is provided from the host system 100 at operation S103. The controller 301 may generate the compressed augmented data unit CADU as a result of the compression operation.

The compressed augmented data unit CADU is an alteration information unit AIU. The alteration information unit AIU may include difference information and data augmentation operation information. The difference information may be information representing a difference between the original data unit ODU and the augmented data unit ADU, which are provided from the host system 100 at operation S103. The data augmentation operation information may be information on the data augmentation operation that has generated the augmented data unit ADU from the original data unit ODU.

In the present disclosure, the terms compressed augmented data unit CADU and alteration information unit AIU refer to the same object and may be used interchangeably.

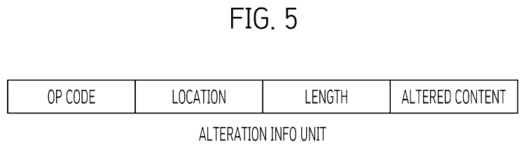

FIG. 5 is an exemplary diagram illustrating an alteration information unit AIU in accordance with another embodiment of the present invention. FIG. 5 illustrates a format of an alteration information unit AIU.

The alteration information unit AIU may not be compressed data simply obtained according to a typical compression scheme. The alteration information unit AIU may include information representing how the corresponding augmented data unit ADU is generated from the corresponding original data unit ODU. In other words, the alteration information unit AIU may be information based on the corresponding original data unit ODU and may include information on the generation of the corresponding augmented data unit ADU. Therefore, the augmented data unit ADU may not be restored simply based on the corresponding alteration information unit AIU only. The augmented data unit ADU may be restored based on a combination of the corresponding original data unit ODU and the corresponding alteration information unit AIU.

Referring to FIG. 5, the alteration information unit AIU may include an operation code field OP CODE, a location field LOCATION, a length field LENGTH and an altered content field ALTERED CONTENT. The value of the operation code field OP CODE may be the data augmentation operation information described above. Each or a combination of the values of the location field LOCATION, the length field LENGTH and the altered content field ALTERED CONTENT may be the difference information described above.

The alteration information unit AIU may selectively have a value for each of the fields according to corresponding original data unit ODU and augmented data unit ADU. In other words, the alteration information unit AIU may selectively have a value for each of the fields according to the data augmentation operation that has been performed on the corresponding original data unit ODU to generate the corresponding augmented data unit ADU.

The operation code field OP CODE may be a field representing the data augmentation operation that has been performed on the corresponding original data unit ODU. In the case of the examples illustrated in FIGS. 3 and 4, the operation code field OP CODE may have a value representing the replacement operation as the data augmentation operation.

The location field LOCATION may be a field representing the starting location among the aforementioned relative locations of the to-be-transformed data pieces that are to be transformed by the data augmentation operation within the original data unit ODU, the relative locations being measured from the starting point of the original data unit ODU. In the case of the examples illustrated in FIGS. 3 and 4, the location field LOCATION may have a value corresponding to the relative location “3”.

The length field LENGTH may be a field representing the length of the to-be-transformed data piece. The length field LENGTH may be associated with the sizes of the to-be-transformed data pieces. In the case of the examples illustrated in FIGS. 3 and 4, the length field LENGTH may have a value corresponding to the length (e.g., a value of “2”) of the to-be-transformed data pieces corresponding to the text “is”.

The altered content field ALTERED CONTENT may be a field representing one or more data pieces that have been transformed by the data augmentation operation. In the case of the examples illustrated in FIGS. 3 and 4, the altered content field ALTERED CONTENT may have a value corresponding to the code “77 61 73” that has been transformed by the data augmentation operation.

For another example, when the original data unit ODU is a data representing an image and the data augmentation operation is an operation of deleting a portion of the image, the operation code field OP CODE of the corresponding alteration information unit AIU may have a value corresponding to the deletion operation. The location field LOCATION of the alteration information unit AIU may have a value corresponding to the starting location among the relative locations of the data pieces corresponding to the to-be-deleted portion of the image. The length field LENGTH of the alteration information unit AIU may have a value corresponding to the length of the data pieces corresponding to the to-be-deleted portion of the image. The altered content field ALTERED CONTENT of the alteration information unit AIU may have a null value.

For another example, when the original data unit ODU is a data representing a text and the data augmentation operation is an operation of deleting a word included in the text, the operation code field OP CODE of the corresponding alteration information unit AIU may have a value corresponding to the deletion operation. The location field LOCATION of the alteration information unit AIU may have a value corresponding to the starting location among the relative locations of the data pieces corresponding to the to-be-deleted word. The length field LENGTH of the alteration information unit AIU may have a value corresponding to the length of the data pieces corresponding to the to-be-deleted word. The altered content field ALTERED CONTENT of the alteration information unit AIU may have a null value.

For another example, when the original data unit ODU is a data representing a text and the data augmentation operation is an operation of changing the location of a word included in the text, i.e., an operation of moving the word, the operation code field OP CODE of the corresponding alteration information unit AIU may have a value corresponding to the movement operation. The location field LOCATION of the alteration information unit AIU may have a value corresponding to the starting location among the relative locations of the data pieces corresponding to the to-be-moved word. The length field LENGTH of the alteration information unit AIU may have a value corresponding to the length of the data pieces corresponding to the to-be-moved word. The altered content field ALTERED CONTENT of the alteration information unit AIU may have a value corresponding to the starting location among target locations, to which the word has been moved. The target locations may be the relative locations measured from the starting point of the original data unit ODU representing the text.

For another example, when the original data unit ODU is a data representing a text and the data augmentation operation is an operation of inserting a new word into the text, the operation code field OP CODE of the corresponding alteration information unit AIU may have a value corresponding to the insertion operation. The location field LOCATION of the alteration information unit AIU may have a value corresponding to the starting location among the relative locations of the data pieces corresponding to the to-be-inserted word. The length field LENGTH of the alteration information unit AIU may have a null value. The altered content field ALTERED CONTENT of the alteration information unit AIU may have a value corresponding to a code representing the word that has been inserted.

For another example, when the original data unit ODU is continuous data such as a video and the data augmentation operation is a cropping or slicing operation of extracting data corresponding to a portion of the continuous data, the operation code field OP CODE of the corresponding alteration information unit AIU may have a value corresponding to the cropping or slicing operation. The location field LOCATION of the alteration information unit AIU may have a value corresponding to the starting location among the relative locations of the data pieces corresponding to the to-be-extracted portion. The length field LENGTH of the alteration information unit AIU may have a value corresponding to the length of the data pieces corresponding to the to-be-extracted portion. The altered content field ALTERED CONTENT of the alteration information unit AIU may have a null value.

As described above, the alteration information unit AIU may not be the data generated by simply compressing the augmented data unit ADU. The alteration information unit AIU may include information representing how the original data unit ODU is transformed through a data augmentation operation to generate the augmented data unit ADU, i.e., information on how to generate the augmented data unit ADU from the original data unit ODU. Therefore, the augmented data unit ADU may not be restored simply based on the corresponding alteration information unit AIU only. The augmented data unit ADU may be restored based on a combination of the corresponding original data unit ODU and the corresponding alteration information unit AIU.

At operation S105, when a plurality of augmented data units ADUs commonly correspond to a single original data unit ODU, the controller 301 may generate a plurality of compressed augmented data units CADUs or a plurality of alteration information units AIUs respectively corresponding to the augmented data units ADUs by comparing each of the augmented data units ADUs with the single original data unit ODU.

Referring back to FIG. 2, at operation S107, the controller 301 may control the storage device 303 to store the compressed augmented data unit CADU or the alteration information unit AIU. The compressed augmented data unit CADU or the alteration information unit AIU may be the ones generated at operation S105.

At operation S107, in addition to the compressed augmented data unit CADU or the alteration information unit AIU, the controller 301 may control the storage device 303 to selectively store the original data unit ODU corresponding to the alteration information unit AIU. For example, in a case where a plurality of alteration information units AIUs commonly correspond to a single original data unit ODU, the controller 301 in the step S107 may control the storage device 303 to store the single original data unit ODU and the alteration information units AIUs. In other words, the original data unit ODU may not be always stored together for each of the alteration information units AIUs.

Preferably, but not necessarily, the controller 301 may control the storage device 303 to store the single original data unit ODU and one or more corresponding alteration information units AIUs in a continuous storage space.

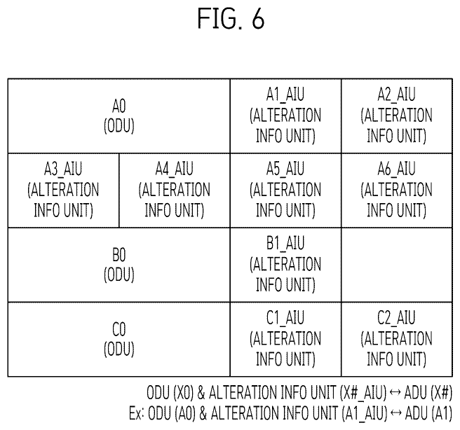

FIG. 6 is an exemplary diagram illustrating a storage in which a compressed augmented data unit CADU is stored in accordance with another embodiment of the present invention.

Referring to FIG. 6, exemplarily, the storage device 303 may store the first to third original data units A0, B0 and C0 in an internal storage area thereof.

Also, exemplarily, the storage device 303 may continuously store, in the internal storage area, the first original data unit A0 together with the first to sixth alteration information units A1_AIU to A6_AIU corresponding to the first original data unit A0. The first original data unit A0 may commonly correspond to the first to sixth alteration information units A1_AIU to A6_AIU.

Also, exemplarily, the storage device 303 may preferably, but not necessarily, continuously store, in the internal storage area, the second original data unit B0 together with the first alteration information unit B1_AIU corresponding to the second original data unit B0. The second original data unit B0 may correspond to the first alteration information unit B1_AIU.

Also, exemplarily, the storage device 303 may preferably, but not necessarily, continuously store, in the internal storage area, the third original data unit C0 together with the first and second alteration information units C1_AIU and C2_AIU corresponding to the third original data unit C0. The third original data unit C0 may commonly correspond to the first and second alteration information units C1_AIU and C2_AIU.

As illustrated in FIG. 6, the controller 301 may control the storage device 303 to store, in a continuous storage space, a single original data unit ODU and one or more corresponding alteration information units AIUs.

As described above, an augmented data unit ADU may be restored based on a combination of corresponding original data unit ODU and alteration information unit AIU. The original data unit ODU and the alteration information unit AIU corresponding to the augmented data unit ADU may be those stored in the storage device 303 at operation S107.

As illustrated in FIG. 6, when one or more alteration information units X #_AIU (where X is A, B or C, and # is a natural number) and a single original data unit X0 commonly corresponding thereto are stored in the storage device 303, the augmented data units X #respectively corresponding to the one or more alteration information units X #_AIU may be restored based on the respective alteration information units X #_AIU and the original data unit X0. According to one embodiment of the present invention, the augmented data unit X # may be the one generated from the original data unit X0 at operation S101.

For example, among the alteration information units A1_AIU to A6_AIU commonly corresponding to the single original data unit A0 and stored in the storage device 303 together with the single original data unit A0, the augmented data unit A1 corresponding to the alteration information unit A1_AIU may be restored based on the single original data unit A0 and the alteration information unit A1_AIU.

Referring back to FIG. 2, when the original data unit ODU and the corresponding augmented data unit ADU are stored in the storage device 303 at operation S107, the storage system 300 may generate map data. The map data may represent the relationship between the augmented data unit ADU, the original data unit ODU and the alteration information unit AIU. For example, the map data may represent the relationship between the logical address and the first and second physical addresses. The logical address may represent the augmented data unit ADU and the first and second physical addresses may respectively represent the original data unit ODU and the alteration information unit AIU corresponding to the augmented data unit ADU. The generated map data may be used when the original data unit ODU and the alteration information unit AIU corresponding to the augmented data unit ADU are read from the storage device 303 in the future.

FIG. 7 is a transaction diagram illustrating an operation between a host system 100 and a storage system 300 in accordance with another embodiment of the present invention.

Referring to FIG. 7, at operation S301, the host system 100 may perform a data augmentation operation. The host system 100 may generate an augmented data unit ADU from an original data unit ODU through the data augmentation operation.

FIG. 3 is an exemplary diagram illustrating an original data unit ODU in accordance with an embodiment of the present invention.

FIG. 3 exemplarily illustrates data corresponding to the text “It is Test” as the original data unit ODU. The code “69 73” corresponding to the relative locations “3” and “4” with reference to the starting point of the original data unit ODU exemplarily illustrated in FIG. 3 may correspond to the text “is”.

FIG. 4 is an exemplary diagram illustrating an augmented data unit ADU in accordance with an embodiment of the present invention.

FIG. 4 exemplarily illustrates data corresponding to the text “It was Test” as the augmented data unit ADU which is generated as a result of performing the data augmentation operation on the original data unit ODU. The code “77 61 73” corresponding to the relative locations “3” to “5” with reference to the starting point of the augmented data unit ADU illustrated in FIG. 4 may correspond to the text “was”.

Comparing the original data unit ODU and the augmented data unit ADU illustrated in FIGS. 3 and 4 with each other, the code representing a specific word as a code corresponding to the relative locations “3” and “4” may be transformed to the code corresponding to the relative locations “3” to “5”. In other words, the text “is” is transformed to the text “was”. Summarizing the examples of FIGS. 3 and 4, the host system 100 may perform, for the original data unit ODU representing the text “It is Test”, a data augmentation operation of transforming the text “is” to the text “was” to generate an augmented data unit ADU corresponding to the text “It was Test”. As described above, the augmented data unit ADU may be data transformed from the original data unit ODU and may be of the same type and the same or similar size as the original data unit ODU.

At operation S301, the host system 100 may perform various data augmentation operations to generate a plurality of augmented data units ADUs from a single original data unit ODU. Each of the augmented data units ADUs may correspond to the single original data unit ODU.

At operation S303, the host system 100—for example, the model learner 101—may perform a compression operation on the augmented data unit ADU, which is generated at operation S301, to generate a compressed augmented data unit CADU. The host system 100 may perform the compression operation based on the original data unit ODU and the generated augmented data unit ADU. The host system 100 may perform the compression operation by comparing the original data unit ODU with the generated augmented data unit ADU. The host system 100 may generate the compressed augmented data unit CADU as a result of the compression operation.

The compressed augmented data unit CADU is an alteration information unit AIU. The alteration information unit AIU may include difference information and data augmentation operation information. The difference information may be information representing the difference between the original data unit ODU and the generated augmented data unit ADU. The data augmentation operation information may be information on the data augmentation operation that has generated the augmented data unit ADU from the original data unit ODU.

FIG. 5 is an exemplary diagram illustrating an alteration information unit AIU in accordance with another embodiment of the present invention. FIG. 5 illustrates a format of the alteration information unit AIU.

The alteration information unit AIU may not be compressed data simply obtained according to a typical compression scheme. The alteration information unit AIU may include information representing how the corresponding augmented data unit ADU is generated from the corresponding original data unit ODU. In other words, the alteration information unit AIU may be information based on the corresponding original data unit ODU and may include information on the generation of the corresponding augmented data unit ADU. Therefore, the augmented data unit ADU may not be restored simply based on the corresponding alteration information unit AIU only. The augmented data unit ADU may be restored based on a combination of the corresponding original data unit ODU and the corresponding alteration information unit AIU.

Referring to FIG. 5, the alteration information unit AIU may include an operation code field OP CODE, a location field LOCATION, a length field LENGTH and an altered content field ALTERED CONTENT. The value of the operation code field OP CODE may be the data augmentation operation information described above. Each or a combination of the values of the location field LOCATION, the length field LENGTH and the altered content field ALTERED CONTENT may be the difference information described above.

The alteration information unit AIU may selectively have a value for each of the fields according to corresponding original data unit ODU and augmented data unit ADU. In other words, the alteration information unit AIU may selectively have a value for each of the fields according to the data augmentation operation that has been performed on the corresponding original data unit ODU to generate the corresponding augmented data unit ADU.

The operation code field OP CODE may be a field representing a data augmentation operation that has been performed on the corresponding original data unit ODU. In the case of the examples illustrated in FIGS. 3 and 4, the operation code field OP CODE may have a value representing the replacement operation as the data augmentation operation.

The location field LOCATION may be a field representing the starting location among the aforementioned relative locations of the to-be-transformed data pieces that are to be transformed by the data augmentation operation within the original data unit ODU, the relative locations being measured from the starting point of the original data unit ODU. In the case of the examples illustrated in FIGS. 3 and 4, the location field LOCATION may have a value corresponding to the relative location “3”.

The length field LENGTH may be a field representing the length of the to-be-transformed data pieces. The length field LENGTH may be associated with the size of the to-be-transformed data pieces. In the case of the examples illustrated in FIGS. 3 and 4, the length field LENGTH may have a value corresponding to the length (e.g., a value of “2”) of the to-be-transformed data piece corresponding to the text “is”.

The altered content field ALTERED CONTENT may be a field representing one or more data pieces that have been transformed by the data augmentation operation. In the case of the examples illustrated in FIGS. 3 and 4, the altered content field ALTERED CONTENT may have a value corresponding to the code “77 61 73” that has been transformed by the data augmentation operation.

For another example, when the original data unit ODU is data representing an image and the data augmentation operation is an operation of deleting a portion of the image, the operation code field OP CODE of the corresponding alteration information unit AIU may have a value corresponding to the deletion operation. The location field LOCATION of the alteration information unit AIU may have a value corresponding to the starting location among the relative locations of the data pieces corresponding to the to-be-deleted portion of the image. The length field LENGTH of the alteration information unit AIU may have a value corresponding to the length of the data pieces corresponding to the to-be-deleted portion of the image. The altered content field ALTERED CONTENT of the alteration information unit AIU may have a null value.

For another example, when the original data unit ODU is a data representing a text and the data augmentation operation is an operation of deleting a word included in the text, the operation code field OP CODE of the corresponding alteration information unit AIU may have a value corresponding to the deletion operation. The location field LOCATION of the alteration information unit AIU may have a value corresponding to the starting location among the relative locations of the data pieces corresponding to the to-be-deleted word. The length field LENGTH of the alteration information unit AIU may have a value corresponding to the length of the data pieces corresponding to the to-be-deleted word. The altered content field ALTERED CONTENT of the alteration information unit AIU may have a null value.

For another example, when the original data unit ODU is a data representing a text and the data augmentation operation is an operation of changing the location of a word included in the text, that is, an operation of moving the word, the operation code field OP CODE of the corresponding alteration information unit AIU may have a value corresponding to the movement operation. The location field LOCATION of the alteration information unit AIU may have a value corresponding to the starting location among the relative locations of the data pieces corresponding to the to-be-moved word. The length field LENGTH of the alteration information unit AIU may have a value corresponding to the length of the data pieces corresponding to the to-be-moved word. The altered content field ALTERED CONTENT of the alteration information unit AIU may have a value corresponding to the starting location among target locations, to which the word has been moved. The target locations may be the relative locations measured from the starting point of the original data unit ODU representing the text.

For another example, when the original data unit ODU is a data representing a text and the data augmentation operation is an operation of inserting a new word into the text, the operation code field OP CODE of the corresponding alteration information unit AIU may have a value corresponding to the insertion operation. The location field LOCATION of the alteration information unit AIU may have a value corresponding to the starting location among the relative locations of the data pieces corresponding to the to-be-inserted word. The length field LENGTH of the alteration information unit AIU may have a null value. The altered content field ALTERED CONTENT of the alteration information unit AIU may have a value corresponding to the code representing the word that has been inserted.

For another example, when the original data unit ODU is continuous data such as a video and the data augmentation operation is a cropping or slicing operation of extracting data corresponding to a portion of the continuous data, the operation code field OP CODE of the corresponding alteration information unit AIU may have a value corresponding to the cropping or slicing operation. The location field LOCATION of the alteration information unit AIU may have a value corresponding to the starting location among the relative locations of the data pieces corresponding to the to-be-extracted portion. The length field LENGTH of the alteration information unit AIU may have a value corresponding to the length of the data pieces corresponding to the to-be-extracted portion. The altered content field ALTERED CONTENT of the alteration information unit AIU may have a null value.

As described above, the alteration information unit AIU may not be data generated by simply compressing the augmented data unit ADU. The alteration information unit AIU may include information representing how the original data unit ODU is transformed through the data augmentation operation to generate the augmented data unit ADU, i.e., information on how to generate the augmented data unit ADU from the original data unit ODU. Therefore, the augmented data unit ADU may not be restored simply based on the corresponding alteration information unit AIU only. The augmented data unit ADU may be restored based on a combination of the corresponding original data unit ODU and the corresponding alteration information unit AIU.

At operation S303, when a plurality of augmented data units ADUs commonly correspond to a single original data unit ODU, the host system 100 may generate a plurality of compressed augmented data units CADUs or a plurality of alteration information units AIUs respectively corresponding to the augmented data units ADUs by comparing each of the augmented data units ADUs with the single original data unit ODU.

Referring back to FIG. 7, at operation S305, the host system 100 may provide the storage system 300 with the original data unit ODU and the alteration information unit AIU which is generated at S303. At operation S301, when a plurality of augmented data units ADUs are generated from a single original data unit ODU and a plurality of alteration information units AIUs for the augmented data units ADUs are generated at operation S303, the host system 100 at operation S305 may provide the storage system 300 with the single original data unit ODU and the alteration information units AIUs.

At operation S307, the controller 301 may control the storage device 303 to store the compressed augmented data unit CADU or the alteration information unit AIU. The compressed augmented data unit CADU or the alteration information unit AIU may be the ones generated at operation S303.

At operation S307, in addition to the compressed augmented data unit CADU or the alteration information unit AIU, the controller 301 may control the storage device 303 to selectively store the original data unit ODU corresponding to the alteration information unit AIU. For example, in a case where a plurality of alteration information units AIUs commonly correspond to a single original data unit ODU, the controller 301 in the step S307 may control the storage device 303 to store the single original data unit ODU and the alteration information units AIUs. In other words, the original data unit ODU may not be always stored together for each of the alteration information units AIUs.

Preferably, but not necessarily, the controller 301 may control the storage device 303 to store the single original data unit ODU and one or more corresponding alteration information units AIUs in a continuous storage space.

FIG. 6 is an exemplary diagram illustrating a storage in which a compressed augmented data unit CADU is stored in accordance with another embodiment of the present invention.

Referring to FIG. 6, exemplarily, the storage device 303 may store first to third original data units A0, B0 and C0 in an internal storage area thereof.

Also, exemplarily, the storage device 303 may continuously store, in the internal storage area, the first original data unit A0 together with the first to sixth alteration information units A1_AIU to A6_AIU. The first original data unit A0 may commonly correspond to the first to sixth alteration information units A1_AIU to A6_AIU.

Also, exemplarily, the storage device 303 may continuously store, in the internal storage area, the second original data unit B0 together with the first alteration information unit B1_AIU corresponding to the second original data unit B0. The second original data unit B0 may correspond to the first alteration information unit B1_AIU.

Also, exemplarily, the storage device 303 may continuously store, in the internal storage area, the third original data unit C0 together with the first and second alteration information units C1_AIU and C2_AIU corresponding to the third original data unit C0. The third original data unit C0 may commonly correspond to the first and second alteration information units C1_AIU and C2_AIU.

As illustrated in FIG. 6, the controller 301 may control the storage device 303 to store, in a continuous storage space, a single original data unit ODU and one or more corresponding alteration information units AIUs.

As described above, the augmented data unit ADU may be restored based on a combination of corresponding original data unit ODU and alteration information unit AIU. The original data unit ODU and the alteration information unit AIU corresponding to the augmented data unit ADU may be those stored in the storage device 303 at operation S307.

As illustrated in FIG. 6, when one or more alteration information units X #AIU (where X is A, B or C, and # is a natural number) and a single original data unit X0 commonly corresponding thereto are stored in the storage device 303, the augmented data units X #respectively corresponding to the one or more alteration information units X #_AIU may be restored based on the respective alteration information units X #_AIU and the original data unit X0. According to one embodiment of the present invention, the augmented data unit X # may be the one generated from the original data unit X0 at operation S301.

For example, among the alteration information units A1_AIU to A6_AIU commonly corresponding to the single original data unit A0 and stored in the storage device 303 together with the single original data unit A0, the augmented data unit A1 corresponding to the alteration information unit A1_AIU may be restored based on the single original data unit A0 and the alteration information unit A1_AIU.

Referring back to FIG. 7, when the original data unit ODU and the corresponding augmented data unit ADU are stored in the storage device 303 at operation S307, the storage system 300 may generate map data. The map data may represent the relationship between the augmented data unit ADU, the original data unit ODU, and the alteration information unit AIU. For example, the map data may represent the relationship between the logical address and the first and second physical addresses. The logical address may represent an augmented data unit ADU and the first and second physical addresses may respectively represent the original data unit ODU and the alteration information unit AIU corresponding to the augmented data unit ADU. The generated map data may be used when the original data unit ODU and the alteration information unit AIU corresponding to the augmented data unit ADU are read from the storage device 303 in the future.

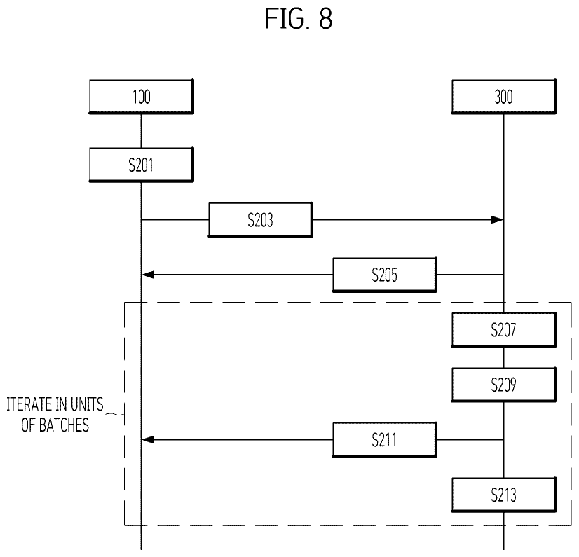

FIG. 8 is a transaction diagram illustrating an operation between the host system 100 and the storage system 300 in accordance with an embodiment of the present invention.

FIG. 8 illustrates a process for the storage system 300 to provide the host system 100 with an augmented data unit ADU. The augmented data unit ADU provided to the host system 100 through the process of FIG. 8 may be used as a target of a learning operation of the host system 100. The process illustrated in FIG. 8 may be performed after the original data unit ODU and the alteration information unit AIU are stored in the storage system 300 through the process described with reference to FIGS. 2 to 7.

Referring to FIG. 8, at operation S201, the host system 100 may provide batch information BATIN.

According to one embodiment of the present invention, the batch information BATIN may be information required for the learning operation of the host system 100. According to one embodiment of the present invention, the batch information BATIN may include information on the augmented data units ADUs corresponding to one or more alteration information units AIUs stored in the storage system 300. According to one embodiment of the present invention, the storage system 300 may provide the host system 100 with one or more augmented data units ADUs based on the batch information BATIN.

According to one embodiment of the present invention, required may be a learning data group as a target data of a learning operation for the host system 100 to perform the learning operation. According to one embodiment of the present invention, the learning data group may be formed of one or more batches. For example, the host system 100 may divide the learning data group into one or more batches.

According to one embodiment of the present invention, the batch information BATIN may be information on one or more batches, which are included in the learning data group and are a target of the learning operation. According to one embodiment of the present invention, the batch included in the learning data group may be a unit of the learning operation. According to one embodiment of the present invention, the batch may be formed of one or more original data units ODUs and/or one or more augmented data units ADUs.

For example, when the process described with reference to FIGS. 2 to 7 is completed, a 100 number of original data units ODUs and alteration information units AIUs may be stored in the storage device 303. The stored alteration information units AIUs may be restored into respective augmented data units ADUs in the future, for example, at operation S207 described below. After the 100 number of original data units ODUs and the alteration information units AIUs are stored in the storage device 303, a 30 number of batches may be required for the host system 100 to perform a learning operation. In this case, the host system 100 may provide, through the batch information BATIN, the storage system 300 with information on the 30 number of required batches. Among the 30 number of batches, a single batch may be formed of a 20 number of data units DUs, each of which may be one of the original data unit ODU and the augmented data unit ADU.

The batch information BATIN may include information on a number of one or more batches as the target of the learning operation, information on an order of the batches and information on one or more data units DUs included in each of the batches. For example, the information on the data units DUs included in a single batch may include information on an order of the data units DUs included in the batch and the type of each of the data units DUs.

Referring to FIG. 8, at operation S203, the host system 100 may provide the storage system 300 with the generated batch information BATIN.

At operation S205, the storage system 300 may provide the host system 100 with address information ADDR. The address information ADDR may represent at least a portion of memory space included in the buffer memory 305. The memory space represented by the address information ADDR may have a capacity capable of accommodating at least a single batch.

Each of the following operations S207 to S213 may be performed in units of batches. As described above, a single batch may include one or more augmented data units ADUs.

At operation S207, the storage system 300 may read out the original data unit ODU and the corresponding alteration information units AIUs, which are stored therein, to restore the corresponding augmented data units ADUs. The storage system 300 may restore the augmented data units ADUs based on the batch information BATIN received at operation S203.

As described above, the batch may be the unit of the learning operation and the batch information BATIN may be information on one or more batches as the target of the learning operation. The batch information BATIN may include information on the number of the batches, the order of the batches and one or more data units DUs included in each of the batches. Accordingly, the storage system 300 may identify, based on the batch information BATIN, the augmented data units ADUs included in the batch.

The storage system 300 may read out, from the storage device 303, the original data unit ODU and the alteration information unit AIU, which are stored through the process described with reference to FIGS. 2 to 7, as a data unit DU corresponding to each of the identified augmented data units ADUs. For example, the storage system 300 may read out, from the storage device 303 and based on the map data described above, the original data unit ODU and the alteration information unit AIU corresponding to each of the identified augmented data units ADUs.

The storage system 300 may restore, from the read-out original data unit ODU and alteration information unit AIU, the corresponding augmented data unit ADU. As described with reference to FIG. 6, for example, among the alteration information units A1_AIU to A6_AIU, which commonly correspond to the single original data unit A0 and are stored in the storage device 303 together with the single original data unit A0, the augmented data unit A1 corresponding to the alteration information unit A1_AIU may be restored based on the single original data unit A0 and the alteration information unit A1_AIU.

At operation S209, the storage system 300 may store the restored augmented data unit ADU in the buffer memory 305. The storage system 300 may store the restored augmented data unit ADU in the memory space represented by the address information ADDR, which is provided to the host system 100 at operation S205. As described above, the address information ADDR may represent at least a portion of memory space included in the buffer memory 305. The memory space may have a capacity capable of accommodating at least a single batch.

At operation S211, the host system 100 may obtain, based on the address information ADDR provided at operation S205, the augmented data unit ADU, which is stored in the memory space at S209.

At operation S213, the storage system 300 may clear the memory space.

The processes of the operations S207 to S213 may be performed for a single batch. The processes of the operations S207 to S213 may be iterated for each of the batches as the target of the learning operation. For example, the iteration may be performed according to a pipeline scheme. Each of the batches may include one or more augmented data units ADUs.

The processes of the operations S207 to S213 may be iterated until the host system 100 are provided with all of one or more augmented data units ADUs corresponding to the alteration information units AIUs stored in the storage system 300. The augmented data units ADUs may be related to the batch information BATIN provided in the step S201 and may be the target of the learning operation.

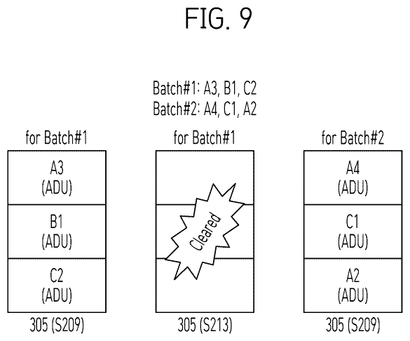

FIG. 9 is an exemplary diagram illustrating a part of the processes illustrated in FIG. 8.

FIG. 9 is an exemplary diagram illustrating at operation S209 and S213. FIG. 9 illustrates a case where a first batch Batch #1 includes first to third augmented data units A3, B1 and C2, and a second batch Batch #2 includes fourth to sixth augmented data units A4, C1, and A2 among a plurality of batches as the target of a learning operation.

Referring to FIG. 8 and FIG. 9, when the operations S207 to S213 are performed for the first batch Batch #1, the storage system 300 in the step S209 may store, in the memory space of the buffer memory 305, the first to third augmented data units A3, B1 and C2 included in the first batch Batch #1. The memory space may be specified by the address information ADDR provided to the host system 100 at operation S205.

Subsequently, at operation S213, the storage system 300 may clear the first to third augmented data units A3, B1 and C2 from the memory space.

Subsequently, in a case where the operations S207 to S213 are performed for the second batch Batch #2, the storage system 300 at operation S209 may store, in the memory space of the buffer memory 305, the fourth to sixth augmented data units A4, C1 and A2 included in the second batch Batch #2.

Although FIGS. 8 and 9 illustrate a case where only the augmented data units ADUs are included in the batch, the present invention may not be limited to this example. For example, the batch may include one or more data units DUs and each of the data units DUs may be one among the original data unit ODU and an augmented data unit ADU. In other words, the data unit DU as the target of the learning operation may be one among the original data unit ODU and the augmented data unit ADU. In this case, the restoration operation of the at operation S207 may not be required for the original data unit ODU that is read out from the storage system 300.

According to the embodiment of the present invention, an augmented data unit ADU may be stored with a smaller capacity.

According to the embodiment of the present invention, a host system may use an augmented data unit ADU without restoring a compressed augmented data unit CADU into the augmented data unit ADU.

According to one embodiment of the present invention, the host system may obtain an augmented data unit ADU from a memory based on the address information provided by a storage system, and therefore, it may not require the time taken for map reading.

According to one embodiment of the present invention, since the augmented data units ADUs included in a learning data group stored in a storage may be rearranged and provided according to a request from the host system, the host system may sequentially obtain the augmented data units ADUs provided by the storage system according to the requests and perform a learning operation.

While the present invention has been described with respect to the specific embodiments, it will be apparent to those skilled in the art that various changes and modifications may be made without departing from the spirit and scope of the invention as defined in the following claims.

What is claimed is:

1. A storage system comprising:
a storage device; and
a controller,
wherein the controller is configured to:
perform, based on an original data unit, a compression operation on each of augmented data units to generate one or more alteration information units respectively corresponding to the augmented data units, the original data unit and the augmented data units being provided from a host system and the augmented data units being a result of a data augmentation operation performed on the original data unit; and
store the original data unit and the alteration information units in the storage device, and
wherein the alteration information unit includes at least one among an operation code field, a location field, a length field and an altered content field.

2. The storage system of claim 1, wherein:
the operation code field has a value representing the data augmentation operation,
the location field has a value corresponding to a starting location of one or more data pieces, which are transformed by the data augmentation operation within the original data unit,
the length field has a value corresponding to a length of the one or more data pieces, and
the altered content field has a value corresponding to the one or more data pieces.

3. The storage system of claim 1, wherein:
the controller is further configured to receive batch information provided from the host system, and
the batch information includes information on augmented data units, which correspond to the alteration information units stored in the storage system and are grouped in units of batches.

4. The storage system of claim 3,
further comprising a memory device, and
wherein the controller is further configured to provide the host system with address information, and
wherein the address information represents at least a partial space within the memory device.

5. The storage system of claim 4, wherein the controller is further configured to restore, based on the original data unit and the alteration information units respectively corresponding to the augmented data units grouped in units of batches and represented by the batch information, the augmented data units grouped in units of batches.

6. The storage system of claim 5, wherein the controller is further configured to store, in the partial space, the restored augmented data units grouped in unit of batches.

7. The storage system of claim 6, wherein the controller is further configured to clear the partial space after the host system acquires, from the partial space, the stored augmented data units grouped in units of batches.

8. A storage system comprising:
a storage device; and
a controller,
wherein the controller is configured to store, in the storage device, an original data unit and one or more alteration information units, the original data unit and the alteration information units being provided from a host system, the alteration information units respectively corresponding to augmented data units and the augmented data units being a result of a data augmentation operation performed on the original data unit, and
wherein the alteration information unit includes at least one among an operation code field, a location field, a length field and an altered content field.

9. The storage system of claim 8, wherein:
the operation code field has a value representing the data augmentation operation,
the location field has a value corresponding to a starting location of one or more data pieces, which are transformed by the data augmentation operation within the original data unit,
the length field has a value corresponding to a length of the one or more data pieces, and
the altered content field has a value corresponding to the one or more data pieces.

10. The storage system of claim 8, wherein:
the controller is further configured to receive batch information provided from the host system, and
the batch information includes information on augmented data units, which correspond to the alteration information units stored in the storage system and are grouped in units of batches.

11. The storage system of claim 10,
further comprising a memory device, and
wherein the controller is further configured to provide the host system with address information, and
wherein the address information represents at least a partial space within the memory device.

12. The storage system of claim 11, wherein the controller is further configured to restore, based on the original data unit and the alteration information units respectively corresponding to the augmented data units grouped in units of batches and represented by the batch information, the augmented data units grouped in units of batches.

13. The storage system of claim 12, wherein the controller is further configured to store, in the partial space, the restored augmented data units grouped in unit of batches.

14. The storage system of claim 13, wherein the controller is further configured to clear the partial space after the host system acquires, from the partial space, the stored augmented data units grouped in units of batches.

15. An operating method of a storage system, the method comprising:
performing, based on an original data unit, a compression operation on each of augmented data units to generate one or more alteration information units respectively corresponding to the augmented data units, the original data unit and the augmented data units being provided from a host system and the augmented data units being a result of a data augmentation operation performed on the original data unit; and
storing the original data unit and the alteration information units in a storage device,
wherein the alteration information unit includes at least one among an operation code field, a location field, a length field and an altered content field.

16. The method of claim 15, wherein:
the operation code field has a value representing the data augmentation operation,
the location field has a value corresponding to a starting location of one or more data pieces, which are transformed by the data augmentation operation within the original data unit,
the length field has a value corresponding to a length of the one or more data pieces, and
the altered content field has a value corresponding to the one or more data pieces.

17. The method of claim 15,
further comprising receiving batch information provided from the host system,
wherein the batch information includes information on augmented data units, which correspond to the alteration information units stored in the storage system and are grouped in units of batches.

18. The method of claim 17,
further comprising providing the host system with address information,
wherein the address information represents at least a partial space within a memory device included in the storage system.

19. The method of claim 18, further comprising restoring, based on the original data unit and the alteration information units respectively corresponding to the augmented data units grouped in units of batches and represented by the batch information, the augmented data units grouped in units of batches.

20. The method of claim 19, further comprising storing, in the partial space, the restored augmented data units grouped in unit of batches.

21. The method of claim 20, further comprising clearing the partial space after the host system acquires, from the partial space, the stored augmented data units grouped in units of batches.
